(19) United States
(12) Patent Application Publication
(10) Pub. No.: US 2007/0086827 A1
(43) Pub. Date: Apr. 19, 2007

(54) Printer

(75) Inventor: Kunio Sawai, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/546,979

(22) Filed: Oct. 13, 2006

(30) Foreign Application Priority Data
Oct. 17, 2005 (JP) 2005-301166

(51) Int. Cl. B41J 13/02

(52) U.S. Cl. 400/634

(57) ABSTRACT

A printer capable of suppressing reduction of printing quality by inhibiting a feed roller from axial deviation is obtained. This printer comprises a feed roller carrying a paper, a feed roller gear mounted with the feed roller for transmitting driving force to the feed roller and a platelike member having an elastically deformable urging portion axially urging at least either the feed roller gear or the feed roller.

### BACKGROUND OF THE INVENTION

1. Field of the Invention

The present invention relates to a printer, and more particularly, it relates to a printer comprising a feed roller.

2. Description of the Background Art

A printer carrying a paper while holding the same between a feed roller and a press roller coming into contact with the feed roller with prescribed pressing force is known in general, as disclosed in Japanese Patent Laying-Open No. 8-156303 (1996) or 2001-88385, for example.

The aforementioned Japanese Patent Laying-Open No. 8-156303discloses a thermal transfer printer (printer) comprising a capstan roller (feed roller) and a pinch roller (press roller). This thermal transfer printer carries a photographic paper (paper) by pressing the photographic paper against the capstan roller with the pinch roller and rotating the capstan roller.

The aforementioned Japanese Patent Laying-Open No. 2001-88385 discloses a sublimatic color printer (printer) comprising a pair of carrier rollers. This sublimatic color printer carries a roll paper (paper) with the pair of carrier rollers (a feed roller and a press roller).

FIG. 15 is a perspective view showing the overall structure of another conventional thermal transfer printer (printer). FIG. 16 is a front elevational view showing motors and gears of the conventional thermal transfer printer shown in FIG. 15. FIGS. 17 and 18 are diagrams for illustrating the conventional thermal transfer printer shown in FIG. 15 in detail. The structure of the conventional thermal transfer printer is described with reference to FIGS. 15 to 18.

As shown in FIG. 15, the conventional thermal transfer printer comprises a chassis 101, a print head 102 for printing, a platen roller 103 (see FIG. 18) opposed to the print head 102, side plates 104 and 105, a take-up reel 107 engaging with an ink sheet cartridge 106, a feed roller 108, a feed roller gear 109, a press roller 110 coming into contact with the feed roller 108 with prescribed pressing force, a pair of press roller bearings 111 rotatably supporting the press roller 110, a bearing support plate 112 supporting the press roller bearings 111, a paper feed roller 113, a paper feed roller gear 114, a paper discharge roller 115, a paper discharge roller gear 116, a motor bracket 117, a paper feed motor 118 for carrying a paper 150 (see FIG. 18), a print head rotating motor 119 rotating the print head 102, a swingable swing gear 120 and a plurality of intermediate gears 121 to 124 (see FIG. 16). The ink sheet cartridge 106 is mounted on the conventional thermal transfer printer.

As shown in FIG. 15, the chassis 101 has a first side surface 101a, a second side surface 101b and a bottom surface 101c coupling the first and second side surfaces 101a and 101b with each other. The aforementioned motor bracket 117 is mounted on the first side surface 101a of the chassis 101. As shown in FIG. 17, the first side surface 101a is mounted with the side plate 104, and provided with a feed roller bearing mounting hole 101d for receiving a feed roller bearing 104a integrally provided on the side plate 104. As shown in FIG. 15, the second side surface 101b of the chassis 101 is mounted with the side plate 105, and provided with a feed roller bearing mounting hole 101f for receiving a feed roller bearing 105a integrally provided on the side plate 105. The second side surface 101b of the chassis 101 and the side plate 105 are provided with cartridge mounting holes 101g and 105c for mounting the ink sheet cartridge 106 on the thermal transfer printer respectively.

As shown in FIGS. 15 and 18, the print head 102 for printing is mounted inside of the first and second side surfaces 101a and 101b of the chassis 101 to be rotatable about a support shaft 102a. As shown in FIG. 18, platen roller bearings (not shown) of the side plates 104 and 105 rotatably support the platen roller 103.

As shown in FIG. 18, the ink sheet cartridge 106 has a take-up portion 106a and a feed portion 106b. A take-up bobbin 106c is rotatably arranged in the take-up portion 106a of the ink sheet cartridge 106. An ink sheet 106e for printing images on the paper 150 is wound on the take-up bobbin 106c and the feed bobbin 106d.

The take-up reel 107 is so formed as to take up the ink sheet 106e from the feed bobbin 106d onto the take-up bobbin 106c by engaging with the take-up bobbin 106c arranged in the take-up portion 106a of the ink sheet cartridge 106 and rotating the take-up bobbin 106c along arrow M2 (see FIG. 18). As shown in FIGS. 15 and 16, the swing gear 120 swings to mesh with a gear portion 107a of the take-up reel 107.

The feed roller bearings 104a (see FIG. 17) and 105a (see FIG. 15) of the side plates 104 and 105 rotatably support the feed roller 108. The feed roller 108 has a function of carrying the paper 150 in a paper feed direction (along arrow F2 in FIG. 18) and a paper discharge direction (along arrow J2 in FIG. 18) while holding the paper 150 (see FIG. 18) between the same and the press roller 110.

As shown in FIG. 15, the press roller bearings 111 rotatably support the press roller 110. These press roller bearings 111 are mounted on the bearing support plate 112. The bearing support plate 112 is so arranged on a bent portion (not shown) and the second side surface 101b of the chassis 101 as to press the press roller 110 against the feed roller 108.

The paper feed roller 113 is provided for feeding the paper 150 (see FIG. 18) to a printing position for printing with the print head 102. As shown in FIG. 15, the paper feed roller 113 has a shaft portion 113a and a roller portion 113b of rubber fitted into the shaft portion 113a. The paper feed roller gear 114 is mounted on an end of the shaft portion 113a of the paper feed roller 113 closer to the first side surface 101a of the chassis 101.

The paper discharge roller 115 is provided for discharging the paper 150 (see FIG. 18) subjected to printing with the print head 102. As shown in FIG. 15, the paper discharge roller 115 has a shaft portion 115a , and a roller portion 115b of rubber fitted into the shaft portion 115a. The paper discharge roller gear 116 is mounted on an end of the shaft portion 115a of the paper discharge roller 115 closer to the first side surface 101a of the chassis 101.

As shown in FIG. 16, a motor gear 118b is mounted on a shaft portion 118a of the paper feed motor 118 mounted on the motor bracket 117. This paper feed motor 118 functions as a drive source for driving the gear portion 107a of the take-up reel 107, the feed roller gear 109, the paper feed roller gear 114, the paper discharge roller gear 116 and the intermediate gears 121 to 124. The print head rotating motor 119 has a function of vertically rotating the print head 102 with respect to the platen roller 103 for pressing/separating the former against/from the latter with a gear (not shown).

In the conventional thermal transfer printer shown in FIGS. 15 to 18, however, a gap L2 is formed between the feed roller gear 109 and the motor bracket 117 due to a working error or the like, as shown in FIG. 17. When horizontal external force is applied to the feed roller 108 carrying the paper 150 in printing, therefore, the feed roller gear 109 and the feed roller 108 mounted on the feed roller gear 109 may move along arrow A2 (see FIG. 17). In this case, the paper 150 held between the feed roller 109 and the press roller 110 also moves along arrow A2 (see FIG. 17), to result in deviation of the printing position. Thus, printing quality is disadvantageously reduced.

Further, each of the conventional printers disclosed in the aforementioned Japanese Patent Laying-Open Nos. 8-156303 3 and 2001-88385 conceivably neither discloses nor suggests a structure preventing the feed roller from axial deviation. Also in this printer, therefore, printing quality is conceivably reduced due to axial deviation of the feed roller similarly to the conventional thermal transfer printer shown in FIGS. 15 to 18.

### SUMMARY OF THE INVENTION

The present invention has been proposed in order to solve the aforementioned problems, and an object of the present invention is to provide a printer capable of suppressing reduction of printing quality by inhibiting a feed roller from axial deviation.

A printer according to a first aspect of the present invention comprises a feed roller carrying a paper, a feed roller gear mounted with the feed roller for transmitting driving force to the feed roller and a platelike member having an elastically deformable urging portion axially urging at least either the feed roller gear or the feed roller.

In the printer according to the first aspect of the present invention, as hereinabove described, the platelike member having the elastically deformable urging portion axially urging at least either the feed roller gear or the feed roller is so provided that the urging portion axially urges at least either the feed roller gear or the feed roller, whereby the printer can rotate at least either the feed roller gear or the feed roller in a state regulating the axial position thereof. Thus, the printer can inhibit the feed roller mounted on the feed roller gear from axial movement when carrying the paper, thereby suppressing axial deviation of the feed roller. Therefore, the printer can inhibit the paper held between the feed roller and the press roller from axial movement when carrying the paper in printing, thereby suppressing reduction of printing quality.

In the aforementioned printer according to the first aspect, the platelike member preferably includes a bracket member for mounting a prescribed component, and the urging portion preferably includes an elastically deformable tongue section formed by notching the bracket member. According to this structure, the printer can easily axially urge either the feed roller gear or the feed roller with the tongue section formed on the bracket portion.

In the aforementioned structure having the urging portion including the tongue section, the tongue section of the bracket member preferably has a projecting portion provided to protrude from a surface of the bracket member closer to the feed roller gear or the feed roller for coming into contact with at least either the feed roller gear or the feed roller. According to this structure, the contact area between the projecting portion of the tongue section and at least either the feed roller gear or the feed roller can be reduced as compared with a case where the overall tongue section comes into contact with at least either the feed roller gear or the feed roller. Thus, the printer can reduce frictional resistance when rotating at least either the feed roller gear or the feed roller while urging at least either the feed roller gear or the feed roller with the projecting portion, thereby suppressing a load applied to at least either the feed roller gear or the feed roller. Therefore, the printer can smoothly rotate at least either the feed roller gear or the feed roller.

In the aforementioned structure having the urging portion including the tongue section, the projecting portion of the tongue section is preferably provided to come into contact with the side end surface of at least either the feed roller gear or the feed roller. According to this structure, the projecting portion of the tongue section comes into contact with the side end surface of at least either the feed roller gear or the feed roller regardless of the angle of rotation of the feed roller gear or the feed roller, whereby the urging portion can regularly axially urge at least the feed roller gear or the feed roller with constant urging force.

In this case, the feed roller gear is preferably made of resin and preferably has a rib on a side opposed to the bracket member, and the projecting portion of the tongue section is preferably provided to come into contact with the side end surface of the rib of the feed roller gear. According to this structure, the printer can inhibit the projecting portion and the side end surface of the rib coming into contact with each other from excessive friction due to the side end surface, made of resin, of the feed roller gear coming into contact with the projecting portion of the tongue section upon rotation of the feed roller gear.

In the aforementioned structure having the projecting portion of the tongue section provided to come into contact with the side end surface of the feed roller, the feed roller preferably has a gear receiving portion for receiving the feed roller gear, and the projecting portion of the tongue section is preferably provided to come into contact with a portion close to the rotation center of the side end surface of the gear receiving portion of the feed roller. According to this structure, the projecting portion of the tongue section so comes into contact with the portion close to the rotation center of the side end surface of the gear receiving portion of the feed roller that the contact length (corresponding to the circumferential length) between the projecting portion and the side end surface of the gear receiving portion of the feed roller can be reduced in rotation, thereby preventing the projecting portion from abrasion resulting from rotation of the feed roller gear.

In the aforementioned structure provided with the tongue section having the projecting portion, the tongue section of the bracket member is preferably L-shaped, and the projecting portion of the tongue section is preferably provided in the vicinity of the forward end of the L-shaped tongue section. According to this structure, the L-shaped tongue section can produce urging force not only by deflection but also by twisting when urging the feed roller gear with the projecting portion thereof, whereby large urging force can be produced by the tongue section smaller than a linear tongue section.

In the aforementioned printer according to the first aspect, the platelike member and at least either the feed roller gear or the feed roller are preferably arranged at a prescribed interval, and the prescribed interval is preferably so set that the urging portion of the platelike member is deformed within the range of elastic deformation when at least either the feed roller gear or the feed roller is pressed by external force toward the platelike member to come into contact with the platelike member against the urging force of the urging portion of the platelike member. According to this structure, the urging portion is deformed within the range of elastic deformation also when at least either the feed roller gear or the feed roller moves to come into contact with the platelike member due to external force applied against the urging force, whereby the printer can prevent the urging portion from deformation.

In the aforementioned printer according to the first aspect, the platelike member is preferably a motor bracket mounted with a motor serving as a drive source for the driving force transmitted to the feed roller. According to this structure, the printer may not be provided with an additional platelike member having an urging portion urging at least either the feed roller gear or the feed roller, whereby the number of components can be inhibited from increase.

In the aforementioned printer according to the first aspect, both of the platelike member having the urging portion and the feed roller are preferably made of metal, and the urging portion is preferably provided to come into contact with the feed roller. According to this structure, charge (static electricity) stored in the feed roller rotatively coming into contact with the paper can be released toward the platelike member through the urging portion with no requirement for an additional member for earthing (grounding), whereby the printer can earth the feed roller while inhibiting the number of components from increase.

A printer according to a second aspect of the present invention comprises a feed roller carrying a paper and a feed roller gear mounted with the feed roller for transmitting driving force to the feed roller and further comprises a platelike member having an elastically deformable urging portion axially urging at least either the feed roller gear or the feed roller, while the platelike member and at least either the feed roller gear or the feed roller are arranged at a prescribed interval, the prescribed interval is so set that the urging portion of the platelike member is deformed within the range of elastic deformation when at least either the feed roller gear or the feed roller is pressed by external force toward the platelike member to come into contact with the platelike member against the urging force of the urging portion of the plate like member, the platelike member is a motor bracket mounted with a motor serving as a drive source for the driving force transmitted to the feed roller, the urging portion includes an elastically deformable tongue section formed by notching the motor bracket, and the tongue section of the motor bracket is L-shaped, and has a projecting portion provided in the vicinity of the forward end of the L-shaped tongue section to protrude from a surface of the motor bracket closer to the feed roller gear or the feed roller for coming into contact with at least either the feed roller gear or the feed roller.

In the printer according to the second aspect of the present invention, as hereinabove described, the platelike member having the elastically deformable urging portion axially urging at least either the feed roller gear or the feed roller is so provided that the urging portion axially urges at least either the feed roller gear or the feed roller, whereby the printer can rotate at least either the feed roller gear or the feed roller in a state regulating the axial position thereof. Thus, the printer can inhibit the feed roller mounted on the feed roller gear from axial movement, thereby suppressing axial deviation of the feed roller. Therefore, the printer can inhibit the paper held between the feed roller and the press roller from axial movement when carrying the paper in printing, thereby suppressing reduction of printing quality. Further, the urging portion is so formed as to include the elastically deformable tongue section formed by notching the motor bracket that the printer can easily axially urge either the feed roller gear or the feed roller with the tongue section formed on the motor bracket. Further, the tongue section has the projecting portion provided to protrude from the surface of the motor bracket closer to the feed roller gear or the feed roller for coming into contact with at least either the feed roller gear or the feed roller, whereby the contact area between the projecting portion of the tongue section and at least either the feed roller gear or the feed roller can be reduced as compared with a case where the overall tongue section comes into contact with at least either the feed roller gear or the feed roller. Thus, the printer can reduce frictional resistance when rotating at least either the feed roller gear or the feed roller while urging at least either the feed roller gear or the feed roller with the projecting portion, thereby suppressing a load applied to at least either the feed roller gear or the feed roller. Therefore, the printer can smoothly rotate at least either the feed roller gear or the feed roller. In addition, the tongue section is L-shaped and the projecting portion is provided in the vicinity of the forward end of the L-shaped tongue section, whereby the L-shaped tongue section can produce urging force not only by deflection but also by twisting when urging the feed roller gear with the projecting portion thereof, whereby large urging force can be produced by the tongue section smaller than a linear tongue section.

According to the second aspect, the platelike member and at least either the feed roller gear or the feed roller are arranged at the prescribed interval, and the prescribed interval is so set that the urging portion of the platelike member is deformed within the range of elastic deformation when at least either the feed roller gear or the feed roller is pressed by external force toward the platelike member to come into contact with the platelike member against the urging force of the urging portion of the platelike member so that the urging portion is deformed within the range of elastic deformation also when at least either the feed roller gear or the feed roller moves to come into contact with the platelike member due to external force applied against the urging force, whereby the printer can prevent the urging portion from deformation. Further, the platelike member is formed by the motor bracket mounted with the motor serving as the drive source for the driving force transmitted to the feed roller so that the printer may not be provided with an additional platelike member having an urging portion urging at least either the feed roller gear or the feed roller, whereby the number of components can be inhibited from increase.

In the aforementioned printer according to the second aspect, the projecting portion of the tongue section is preferably provided to come into contact with the side end surface of at least either the feed roller gear or the feed roller. According to this structure, the projecting portion of the tongue section comes into contact with the side end surface of at least either the feed roller gear or the feed roller regardless of the angle of rotation of the feed roller gear or the feed roller, whereby the urging portion can regularly axially urge at least the feed roller gear or the feed roller with constant urging force.

In the aforementioned printer according to the second aspect, the feed roller gear is preferably made of resin and preferably has a rib on a side opposed to the motor bracket, and the projecting portion of the tongue section is preferably provided to come into contact with the side end surface of the rib of the feed roller gear. According to this structure, the printer can inhibit the projecting portion and the side end surface of the rib coming into contact with each other from excessive friction due to the side end surface, made of resin, of the feed roller gear coming into contact with the projecting portion of the tongue section upon rotation of the feed roller gear.

In the aforementioned printer according to the second aspect, the feed roller preferably has a gear receiving portion for receiving the feed roller gear, and the projecting portion of the tongue section is preferably provided to come into contact with a portion close to the rotation center of the side end surface of the gear receiving portion of the feed roller. According to this structure, the projecting portion of the tongue section so comes into contact with the portion close to the rotation center of the side end surface of the gear receiving portion of the feed roller that the contact length (corresponding to the circumferential length) between the projecting portion and the side end surface of the gear receiving portion of the feed roller can be reduced in rotation, thereby preventing the projecting portion from abrasion resulting from rotation of the feed roller gear.

In the aforementioned printer according to the second aspect, both of the platelike member having the urging portion and the feed roller are preferably made of metal, and the urging portion is preferably provided to come into contact with the feed roller. According to this structure, charge (static electricity) stored in the feed roller rotatively coming into contact with the paper can be released toward the platelike member through the urging portion with no requirement for an additional member for earthing (grounding), whereby the printer can earth the feed roller while inhibiting the number of components from increase.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a thermal transfer printer according to a first embodiment of the present invention;

FIG. 2 is a front elevational view showing motors and gears of the thermal transfer printer according to the first embodiment shown in FIG. 1;

FIG. 3 is a perspective of the thermal transfer printer according to the first embodiment shown in FIG. 1 as viewed from a second side surface of a chassis;

FIG. 4 is a plan view of the thermal transfer printer according to the first embodiment shown in FIG. 1;

FIG. 5 is an exploded perspective view showing the chassis and a side plate of the thermal transfer printer according to the first embodiment shown in FIG. 1;

FIG. 6 is a perspective view showing the chassis and the side plate of the thermal transfer printer according to the first embodiment shown in FIG. 1;

FIGS. 7 and 8 are plan views showing a motor bracket of the thermal transfer printer according to the first embodiment shown in FIG. 1;

FIGS. 9 and 10 are perspective view showing a feed roller gear and a feed roller of the thermal transfer printer according to the first embodiment shown in FIG. 1;

FIG. 11 is a sectional view showing a portion around the feed roller of the thermal transfer printer according to the first embodiment shown in FIG. 1;

FIG. 12 is a sectional view for illustrating the structure and operations of the thermal transfer printer according to the first embodiment shown in FIG. 1;

FIG. 13 is a sectional view for illustrating a paper carrying operation of the thermal transfer printer according to the first embodiment shown in FIG. 1 following a printing operation;

FIG. 14 is a sectional view showing a portion around a feed roller gear of a thermal transfer printer according to a second embodiment of the present invention;

FIG. 15 is a perspective view showing the overall structure of a conventional thermal transfer printer;

FIG. 16 is a front elevational view showing motors and gears of the conventional thermal transfer printer shown in FIG. 15;

FIG. 17 is a sectional view showing a portion around a feed roller gear of the conventional thermal transfer printer shown in FIG. 15; and

FIG. 18 is a sectional view showing the structure of the conventional thermal transfer printer shown in FIG. 15.

### DESCRIPTION OF THE PREFERRED EMBODIMENTS

Embodiments of the present invention are now described with reference to the drawings.

### FIRST EMBODIMENT

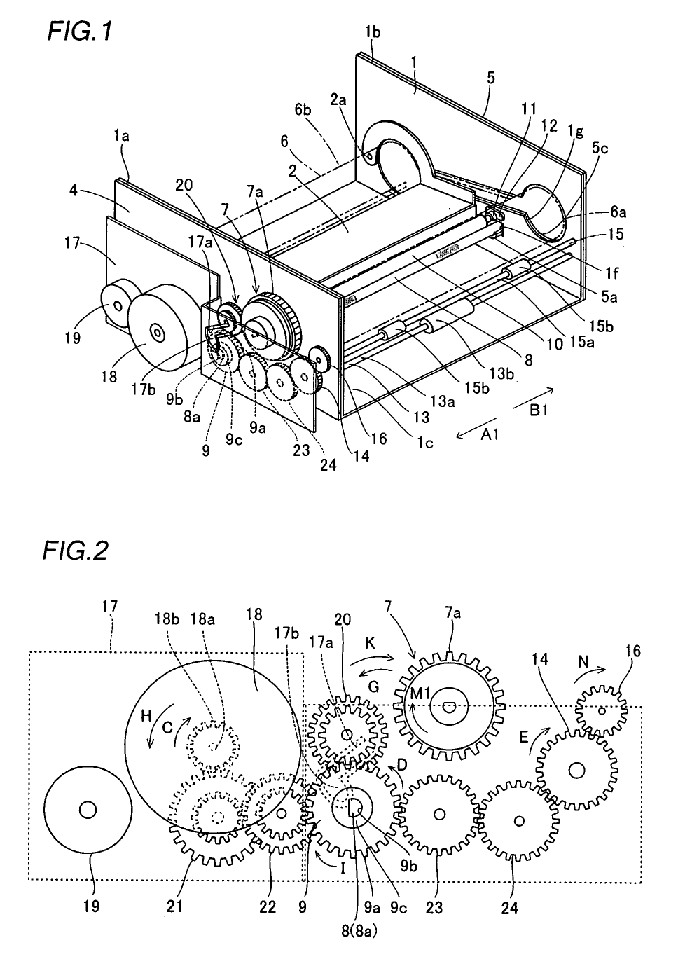

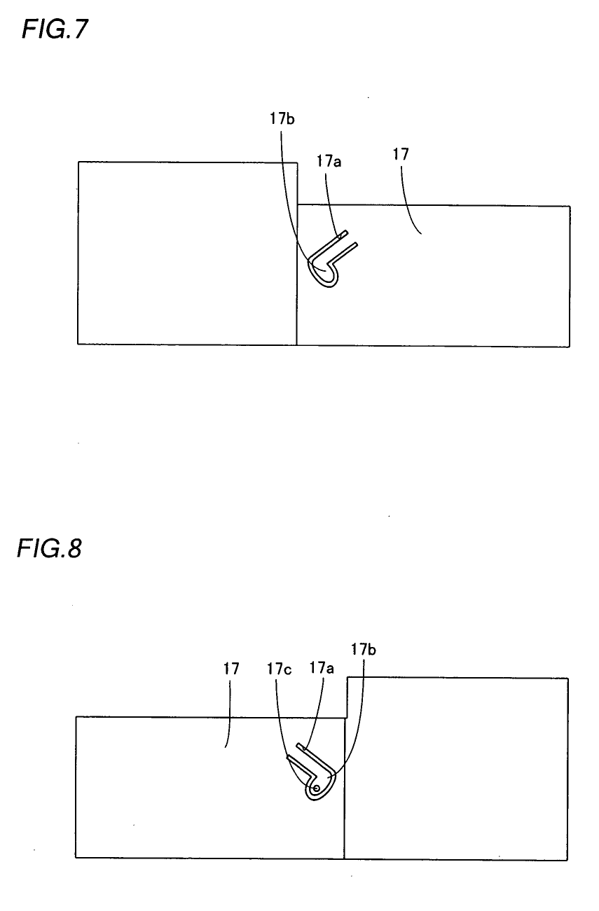

The structure of a thermal transfer printer according to a first embodiment of the present invention is described with reference to FIGS. 1 to 12. The first embodiment of the present invention is applied to the thermal transfer printer, which is an exemplary printer.

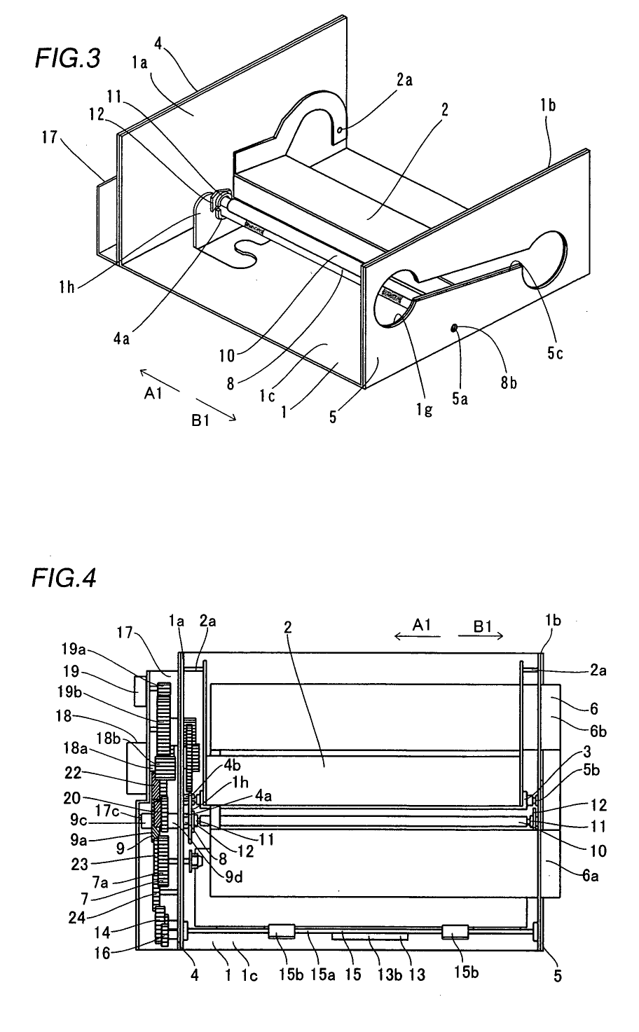

As shown in FIGS. 1 and 3, the thermal transfer printer according to the first embodiment of the present invention comprises a chassis 1 of metal, a print head 2 for printing, a platen roller 3 (see FIG. 4) opposed to the print head 2, side plates 4 and 5 of resin, a take-up reel 7 engaging with an ink sheet cartridge 6, a feed roller 8, a feed roller gear 9 of resin, a press roller 10 of metal coming into contact with the feed roller 8 with prescribed pressing force, a pair of press roller bearings 11 of resin rotatably supporting the press roller 10, a bearing support plate 12 of metal supporting the press roller bearing 11, a paper feed roller 13, a paper feed roller gear 14, a paper discharge roller 15, a paper discharge roller gear 16, a motor bracket 17, a paper feed motor 18 for carrying a paper 50 (see FIG. 12), a print head rotating motor 19 rotating the print head 2, a swingable swing gear 20 and a plurality of intermediate gears 21 to 24 (see FIG. 2). The ink sheet cartridge 6 is mounted on the thermal transfer printer according to the first embodiment. The motor bracket 17 is an example of the “platelike member” or the “bracket member” in the present invention, and the paper feed motor 18 is an example of the “motor” in the present invention.

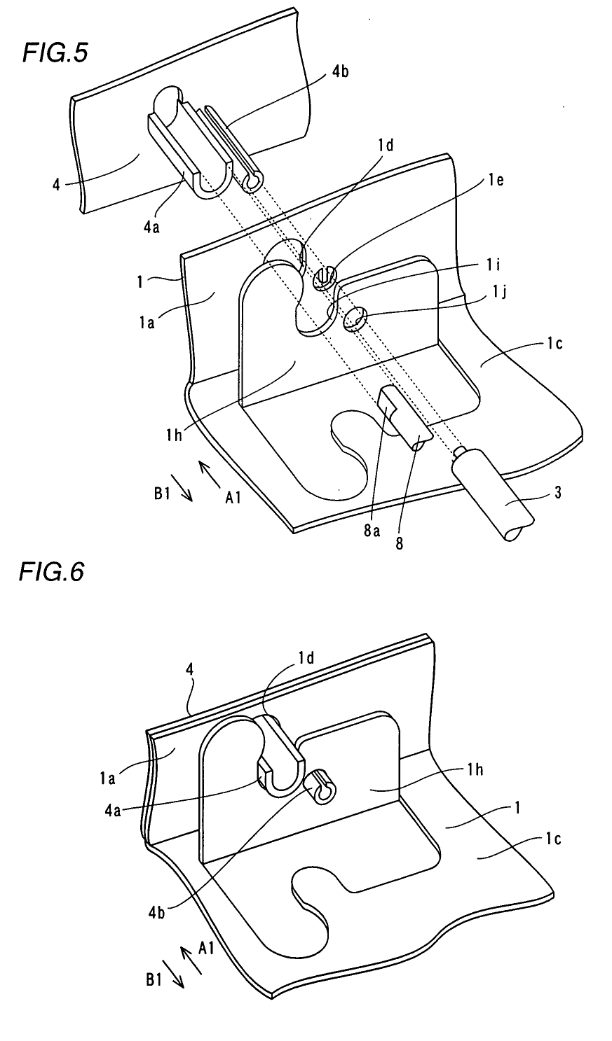

As shown in FIGS. 1 and 3, the chassis 1 has a first side surface 1a, a second side surface 1b and a bottom surface 1c coupling the first and second side surfaces 1a and 1b with each other. The aforementioned motor bracket 17 is mounted on the first side surface 1a of the chassis 1. The side plate 4 of resin is mounted on the first side surface 1a of the chassis 1. As shown in FIGS. 5 and 6, the first side surface 1a of the chassis 1 has a feed roller bearing mounting hole 1d and a platen roller bearing mounting hole 1e for receiving a feed roller bearing 4a and a platen roller bearing 4b integrally mounted on the side plate 4 of resin respectively. The other side plate 5 of resin is mounted on the second side surface 1b of the chassis 1, as shown in FIG. 1. As shown in FIG. 1, the second side surface 1b of the chassis 1 has a feed roller bearing mounting hole 1f and a platen roller bearing mounting hole (not shown) for receiving a feed roller bearing 5a and a platen roller bearing 5b (see FIG. 4) integrally provided on the side plate 5 of resin respectively. Cartridge mounting holes 1g and 5c for mounting the ink sheet cartridge 6 on the thermal transfer printer are provided on the second side surface 1b of the chassis 1 and the side plate 5 respectively.

As shown in FIGS. 3, 5 and 6, the bottom surface 1c of the chassis 1 of metal includes a bent portion 1hintegrally formed on the bottom surface 1c. As shown in FIGS. 5 and 6, the bent portion 1h includes a feed roller bearing support portion 1i and a platen roller bearing support portion 1j supporting the feed roller bearing 4a and the platen roller bearing 4b integrally provided on the side plate 4 respectively.

As shown in FIGS. 1 and 3, the print head 2 employed for printing is mounted inside the first and second side surfaces 1a and 1b of the chassis 1 to be rotatable about a support shaft 2a. As shown in FIG. 4, the platen roller bearings 4b and 5b of the side plates 4 and 5 rotatably support the platen roller 3.

As shown in FIG. 12, the ink sheet cartridge 6 has a take-up portion 6a and a feed portion 6b. A take-up bobbin 6c is rotatably arranged in the take-up portion 6a of the ink sheet cartridge 6. A feed bobbin 6d is rotatably arranged in the feed portion 6b of the ink sheet cartridge 6. An ink sheet 6e for printing images on the paper 50 is wound on the take-up bobbin 6c and the feed bobbin 6d. The ink sheet 6e includes a Y (yellow) ink sheet, an M (magenta) ink sheet and a C (cyan) ink sheet.

The take-up reel 7 (see FIG. 2) is so formed as to take up the ink sheet 6e from the feed bobbin 6d onto the take-up bobbin 6c by engaging with the take-up bobbin 6c arranged in the take-up portion 6a of the ink sheet cartridge 6 and rotating the take-up bobbin 6c along arrow M1 (see FIG. 2). As shown in FIGS. 1 and 2, the swing gear 20 swings to mesh with a gear portion 7a of the take-up reel 7.

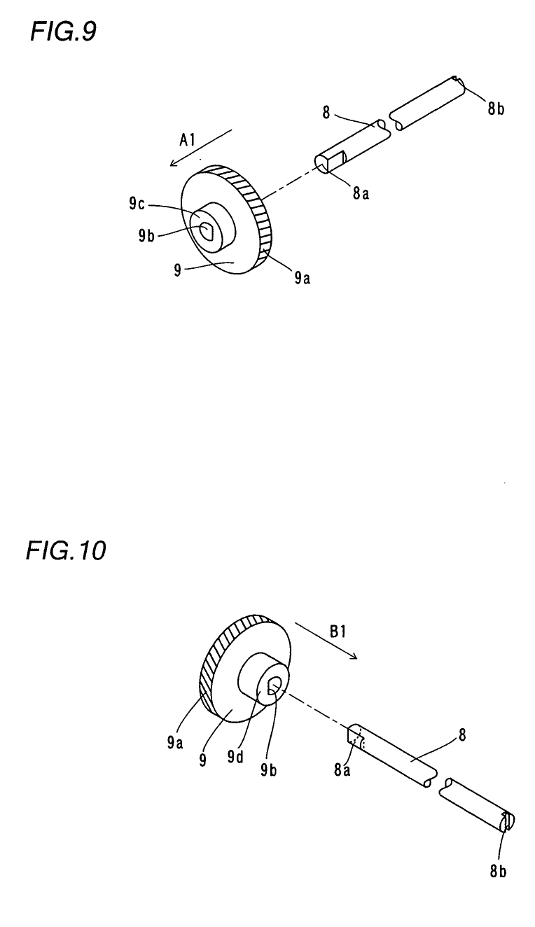

The feed roller bearings 4a (see FIG. 3) and 5a (see FIG. 1) of the side plates 4 and 5 rotatably support the feed roller 8 of metal. The feed roller 8 of metal has a D-shaped gear receiving portion 8a provided on an end closer to the feed roller gear 9 and a driver engaging groove 8b provided on another end opposite to the feed roller gear 9, as shown in FIGS. 9 and 10. The driver engaging groove 8b of the feed roller 8 is provided for engaging with a minus driver so that a user manually rotates the feed roller 8 when a paper jam takes place between the feed roller 8 and the press roller 10. More specifically, the user rotates the minus driver engaging with the drive engaging groove 8b exposed from the feed roller bearing 5a of the side plate 5 as shown in FIG. 3 along arrow I (see FIG. 2), thereby rotating the feed roller 8 along arrow I (see FIG. 2). Thus, the user can discharge the paper 50 (see FIG. 12) from between the feed roller 8 and the press roller 10.

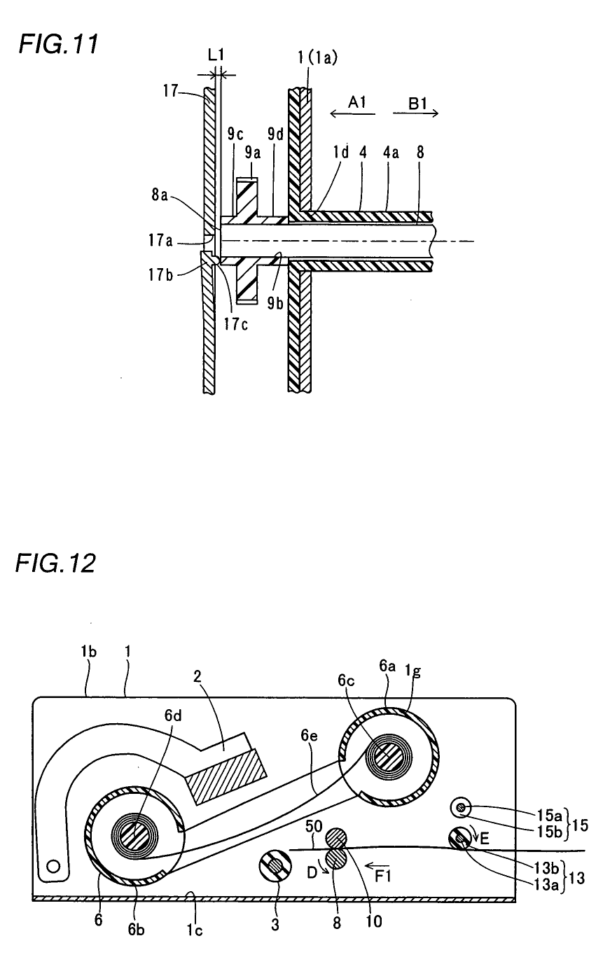

As shown in FIGS. 10 an 11, the feed roller gear 9 of resin has a helical gear portion 9a having teeth obliquely formed with respect to the axis, a D-shaped mounting hole 9b and ribs 9c and 9d. The helical gear portion 9a of the feed roller 9 has a function of smoothing rotation of the feed roller gear 9 due to continuous meshing of the obliquely formed teeth. As shown in FIGS. 2 and 4, force is applied to the feed roller gear 9 along arrow B1 (see FIG. 1) through the teeth of the helical gear portion 9a when the feed roller gear 9 rotates along arrow D (paper feed direction) in FIG. 2, while force is applied to the feed roller gear 9 along arrow A1 (see FIG. 11) through the helical gear portion 9a when the feed roller gear 9 rotates along arrow I (paper discharge direction) in FIG. 2. The gear receiving portion 8a of the feed roller 8 is press-fitted into the mounting hole 9b of the feed roller gear 9 in an unidling manner. The rib 9c of the feed roller gear 9 is so formed as to protrude from a first surface of the feed roller gear 9 along arrow A1 (toward the motor bracket 17), as shown in FIGS. 9 and 11. Further, the rib 9d of the feed roller gear 9 is so formed as to protrude from a second surface of the feed roller gear 9 along arrow B1 (toward the side plate 4), as shown in FIGS. 10 and 11.

As shown in FIGS. 1 and 3, the press roller bearing 11 rotatably supports the press roller 10. This press roller bearing 11 is mounted on the bearing support plate 12. The bearing support plate 12 is so arranged on the bent portion 1h and the second side surface 1b of the chassis 1 as to press the press roller 10 against the feed roller 8.

The paper feed roller 13 is provided for feeding the paper 50 (see FIG. 12) to a printing position for printing with the print head 2. As shown in FIG. 1, this paper feed roller 13 has a shaft portion 13a of metal and a roller portion 13b of rubber fitted into the shaft portion 13a. The paper feed roller gear 14 is mounted on an end of the shaft portion 13a of the paper feed roller 13 closer to the first side surface 1a of the chassis 1.

The paper discharge roller 15 is provided for discharging the paper 50 (see FIG. 12) subjected to printing with the print head 2. As shown in FIG. 1, the paper discharge roller 15 has a shaft portion 15a of metal and a roller portion 15b of rubber fitted into the shaft portion 15a. The paper feed roller gear 16 is mounted on an end of the shaft portion 15a of the paper discharge roller 15 closer to the first side surface 1a of the chassis 1.

According to the first embodiment, a tongue section 17b formed by a notch 17a is provided on the motor bracket 17 of metal (sheet metal). The tongue section 17b is an example of the “urging portion” in the present invention. The tongue section 17b of the motor bracket 17 is L-shaped, and has a projecting portion 17c protruding toward the inner surface of the motor bracket 17 along arrow B1 (see FIG. 11). As shown in FIG. 8, the projecting portion 17c, formed in the vicinity of the forward end of the tongue section 17b, has a function of urging the side end surface of the rib 9c of the feed roller gear 9 of resin along arrow B1 (see FIG. 11). Thus, the rib 9d of the feed roller gear 9 comes into contact with the side plate 4, as shown in FIG. 11. The projecting portion 17c of the motor bracket 17 of metal, coming into contact with the side end surface of the rib 9c of the feed roller gear 9 of resin as shown in FIG. 11, can be prevented from abrasion dissimilarly to a case where the projecting portion 17c of the motor bracket 17 of metal comes into contact with the gear receiving portion 8a of the feed roller 8 of metal. As shown in FIG. 11, the motor bracket 17 mounted on the first side surface 1a of the chassis 1 is at an interval L1 (about 0.5 mm) from the feed roller gear 9. This interval L1 (about 0.5 mm) is so set that the tongue section 17b is deformed within the range of elastic deformation when the feed roller gear 9 is pressed by external force applied from a minus driver or the like engaging with the driver engaging groove 8b along arrow A1 (see FIG. 11) to come into contact with the motor bracket 17 against the urging force of the tongue section 17b.

As shown in FIG. 2, a motor gear 18b is mounted on a shaft portion 18a of the paper feed motor 18 mounted on the motor bracket 17. This paper feed motor 18 functions as a drive source for driving the gear portion 7a of the take-up reel 7, the feed roller gear 9, the paper feed roller gear 14, the paper discharge roller gear 16 and the intermediate gears 21 to 24. The print head rotating motor 19 has a function of vertically rotating the print head 2 with respect to the platen roller 3 for pressing/separating the former against/from the latter with gears 19a and 19b (see FIG. 4). The paper feed motor 18 and the print head rotating motor 19 are examples of the “prescribed component” in the present invention.

A printing operation of the thermal transfer printer according to the first embodiment of the present invention is now described with reference to FIGS. 2 and 11 to 13.

In paper feeding, the motor gear 18b mounted on the paper feed motor 18 rotates along arrow C in FIG. 2 following driving of the paper feed motor 18, to rotate the feed roller gear 9 along arrow D in FIG. 2 through the intermediate gears 21 and 22. Following this rotation of the feed roller gear 9 along arrow D in FIG. 2, the feed roller gear 14 rotates along arrow E in FIG. 2 through the intermediate gears 23 and 24. Thus, the paper feed roller 13 also rotates along arrow E in FIG. 12 following the rotation of the feed roller gear 14, thereby carrying the paper 50 in the paper feed direction (along arrow F1 in FIG. 12) in contact with the lower surface of the roller portion 13b of the paper feed roller 13. Thereafter the feed roller 8 and the press roller 10 carry the paper 50 to a printing start position.

At this time, the feed roller 8 rotates along arrow D in FIG. 12 following the feed roller gear 9 rotating along arrow D in FIG. 2, thereby carrying the paper 50 in the paper feeding direction (along arrow F1 in FIG. 12). The swingable swing gear 20 (see FIG. 2) swings in a direction (along arrow G in FIG. 2) for separating from the gear portion 7a of the take-up reel 7, not to mesh with the gear portion 7a of the take-up reel 7. Thus, the gear portion 7a of the take-up reel 7 remains unrotational in paper feeding, not to take up the ink sheet 6e wound on the take-up bobbin 6c and the feed bobbin 6e.

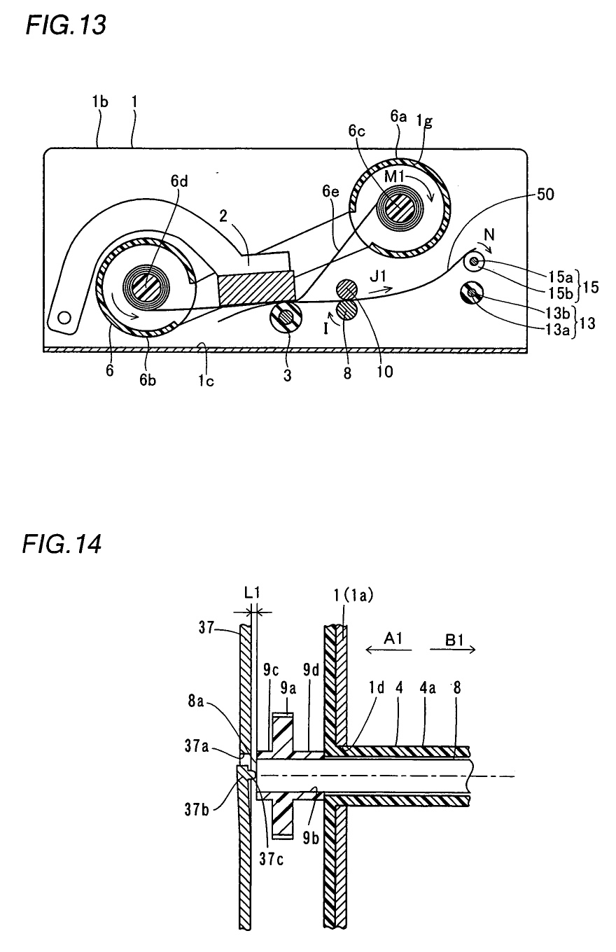

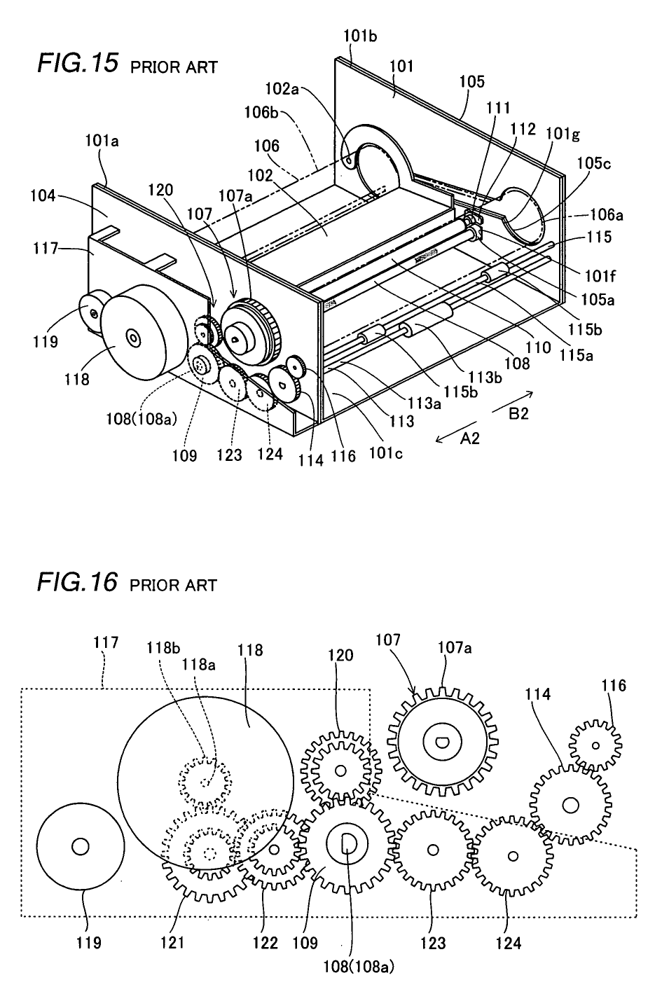

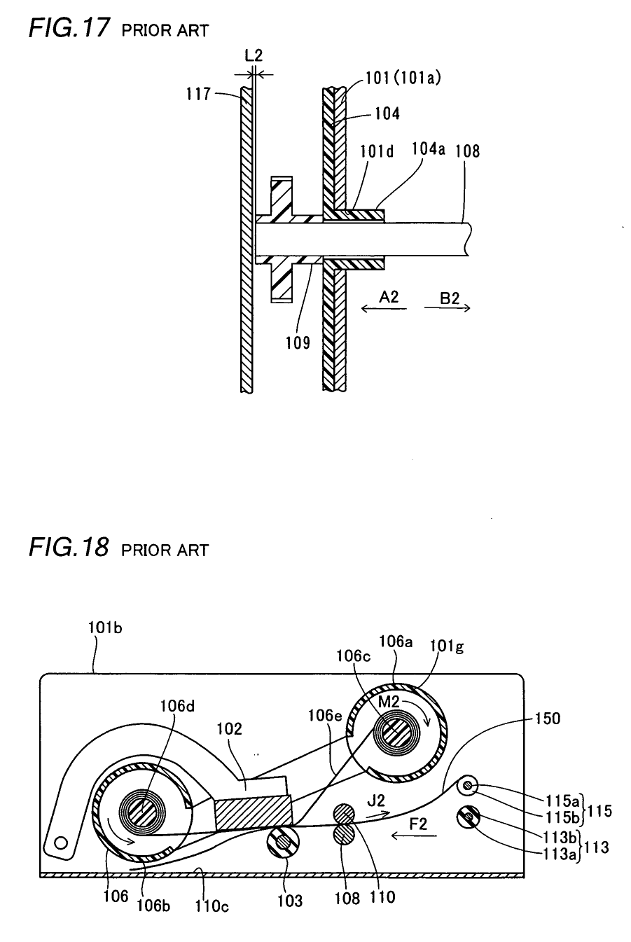

In printing, the motor gear 18b mounted on the paper feed gear 18 rotates along arrow H in FIG. 2 following driving of the paper feed motor 18, to rotate the feed roller gear 9 along arrow I in FIG. 2 through the intermediate gears 21 and 22. Thus, the feed roller 8 rotates along arrow I in FIG. 13 following the rotation of the feed roller gear 9 along arrow I in FIG. 2, for carrying the paper 50 in a paper discharge direction (along arrow J1 in FIG. 13). The swingable swing gear 20 (see FIG. 2) swings in a direction (along arrow K in FIG. 2) for meshing with the gear portion 7a of the take-up reel 7, to mesh with the gear portion 7a of the take-up reel 7. Thus, the gear portion 7a of the take-up reel 7 rotates along arrow M1 in FIG. 2, for taking up the ink sheet 6e wound on the feed bobbin 6d on the take-up bobbin 6c. At this time, the print head 2 rotates toward the platen roller 3, for performing printing on the paper 50 while carrying the paper 50 in the paper discharge direction (along arrow J1 in FIG. 13) and taking up the ink sheet 6e. The thermal transfer printer performs this printing operation every color of the Y (yellow), M (magenta) and C (cyan) ink sheets included in the ink sheet 6e. More specifically, the thermal transfer printer first performs printing in yellow, and thereafter carries the paper 50 to the printing start position in the paper feeding direction (along arrow F1 in FIG. 12). Thereafter the thermal transfer printer performs printing in magenta. Thereafter the thermal transfer printer carries the paper 50 to the printing start position, and performs printing in cyan.

In paper discharge, the paper discharge roller 15 carries the paper 50 subjected to printing with the print head 2 to a dischargeable position, as shown in FIG. 13. At this time, the paper discharge roller gear 16 rotates along arrow N in FIG. 2 through the intermediate gears 23 and 24 and the paper feed roller gear 14, following the rotation of the feed roller gear 9 along arrow I in FIG. 2. Thus, the paper discharge roller 15 also rotates along arrow N in FIG. 13 following the rotation of the paper discharge roller gear 16, to carry the printed paper 50 in the paper discharge direction (along arrow J1 in FIG. 13) in contact with the upper surface of the roller portion 15b of the paper discharge roller 15.

According to the first embodiment, the projecting portion 17c of the motor bracket 17 urges the feed roller 9 along arrow B1 (see FIG. 11) in paper feeding, printing and paper discharge to rotate the feed roller gear 9 having the helical gear portion 9a along arrow D (paper discharge direction) in FIG. 12 or along arrow I (paper discharge direction) in FIG. 13 so that the feed roller gear 9 and the feed roller 8 do not move in the axial direction (along arrows A1 and B1 in FIG. 11) also when force along arrow A1 or B1 (see FIG. 11) or unintended external force is applied to the feed roller gear 9, not to move the paper 50 carried by the feed roller 8 and the press roller 10 in the axial direction (along arrows A1 and B1 in FIG. 11).

According to the first embodiment, as hereinabove described, the motor bracket 17 having the elastically deformable tongue section 17b urging the feed roller gear 9 along arrow B1 (see FIG. 11) is so provided that the tongue section 17b urges the feed roller gear 9 along arrow B1 (see FIG. 1), whereby the thermal transfer printer can rotate the feed roller gear 9 in a state regulating the position thereof in the axial direction (along arrows A1 and B1 in FIG. 11). Thus, the thermal transfer printer can inhibit the feed roller 8 mounted on the feed roller gear 9 from moving in the axial direction (along arrows A1 and B1 in FIG. 11) when carrying the paper 50, thereby inhibiting the same from deviation in the axial direction (along arrows A1 and B1 in FIG. 11). Therefore, the thermal transfer printer can inhibit the paper 50 held between the feed roller 8 and the press roller 10 from moving in the axial direction (along arrows A1 and B1 in FIG. 11) when carrying the paper 50 for printing, thereby suppressing reduction of printing quality.

According to the first embodiment, the thermal transfer printer can easily urge the feed roller gear 9 along arrow B1 (see FIG. 11) with the tongue section 17b provided by forming the notch 17a on the motor bracket 17.

According to the first embodiment, the tongue section 17b has the projecting portion 17c provided to protrude from the surface of the motor bracket 17 for coming into contact with the feed roller gear 9, whereby the contact area between the projecting portion 17c of the tongue section 17b and the feed roller gear 9 can be reduced as compared with a case where the overall tongue section 17b comes into contact with the feed roller gear 9. Thus, the thermal transfer printer can reduce frictional resistance when rotating the feed roller gear 9 while urging the same along arrow B1 (see FIG. 11) with the projecting portion 17c, thereby suppressing a load applied to the feed roller gear 9. Thus, the thermal transfer gear can smoothly rotate the feed roller gear 9.

According to the first embodiment, the projecting portion 17c of the tongue section 17b is provided to come into contact with the side end surface of the feed roller gear 9 so that the projecting portion 17c of the tongue section 17b comes into contact with the side end surface of the feed roller gear 9 regardless of the angle of rotation of the feed roller gear 9, whereby the thermal transfer printer can regularly axially urge the feed roller gear 9 with constant urging force.

According to the first embodiment, the feed roller gear 9 of resin has the rib 9c on the side opposite to the motor bracket 17 while the projecting portion 17c of the tongue section 17b is provided to come into contact with the side end surface of the rib 9c of the feed roller gear 9, whereby the thermal transfer printer can inhibit the projecting portion 17c and the side end surface of the rib 9c coming into contact with each other from excessive friction due to the side end surface, made of resin, of the rib 9c of the feed roller gear 9 coming into contact with the projecting portion 17c of the tongue section 17b upon rotation of the feed roller gear 9.

According to the first embodiment, the tongue section 17b of the motor bracket 17 is L-shaped and provided with the projecting portion 17c around the forward end thereof so that the L-shaped tongue section 17b can produce urging force not only by deflection but also by twisting when urging the feed roller gear 9 along arrow B1(see FIG. 11) with the projecting portion 17c thereof, whereby large urging force can be produced by the tongue section 17b smaller than a linear tongue section.

According to the first embodiment, the motor bracket 17 and the feed roller gear 9 are arranged at the prescribed interval L1 (about 0.5 mm) while the prescribed interval L1 (about 0.5 mm) is so set that the tongue section 17b of the motor bracket 17 is deformed within the range of elastic deformation when the feed roller gear 9 is pressed by external force applied along arrow A1 (see FIG. 11) to come into contact with the motor bracket 17 against the urging force of the tongue section 17b of the motor bracket 17 along arrow B1 (see FIG. 11). Also when the feed roller gear 9 moves to come into contact with the motor bracket 17 due to external force applied along arrow A1 (see FIG. 11) against the urging force along arrow B1 (see FIG. 11) by a minus driver or the like engaging with the driver engaging groove 8b, therefore, the thermal transfer printer can prevent the tongue section 17b, deformed within the range of elastic deformation, from deformation.

According to the first embodiment, the motor bracket 17 mounted with the paper feed motor 18 serving as the drive source for the driving force transmitted to the feed roller 8 is provided with the tongue section 17b urging the feed roller gear 9 so that no platelike member may be separately provided for regulating the position of the feed roller gear 9 in the axial direction (along arrows Al and B1 in FIG. 11), whereby the number of components can be inhibited from increase.

### SECOND EMBODIMENT

Referring to FIG. 14, a thermal transfer printer according to a second embodiment of the present invention is described with reference to a portion around a feed roller gear 9, which is different in structure from that in the thermal transfer printer according to the first embodiment. The remaining structure of the thermal transfer printer according to the second embodiment is similar to that of the thermal transfer printer according to the aforementioned first embodiment, and hence redundant description is not repeated.

According to the second embodiment, a projecting portion 37c provided around the forward end of a tongue section 37b formed on a motor bracket 37 of metal (sheet metal) has a function of urging a gear receiving portion 8a of a feed roller 8 of metal press-fitted into the feed roller gear 9 of resin along arrow B1, as shown in FIG. 14. Thus, a rib 9d of the feed roller gear 9 comes into contact with a side plate 4. At this time, the projecting portion 37c provided around the forward end of the tongue section 37b urges a portion close to the rotation center of the gear receiving portion 8a of the feed roller 8.

As shown in FIG. 14, the motor bracket 37, mounted on a first side surface 1a of a chassis 1, is at an interval L1 (about 0.5 mm) from the feed roller gear 9. This interval L1 (about 0.5 mm) is so set that the tongue section 37b is deformed within the range of elastic deformation when the feed roller gear 9 is pressed by external force applied from a minus driver or the like engaging with a driver engaging groove 8b along arrow A1 to come into contact with the motor bracket 37 against the urging force of the tongue section 37b.

An operation of the thermal transfer printer according to the second embodiment for carrying a paper for printing is similar to that of the thermal transfer printer according to the aforementioned first embodiment, and hence redundant description is not repeated.

According to the second embodiment, as hereinabove described, the motor bracket 37 having the elastically deformable tongue section 37b urging the feed roller 8 along arrow B1 (see FIG. 14) is so provided that the tongue section 37b urges the gear receiving portion 8a of the feed roller 8 along arrow B1 (see FIG. 14), whereby the thermal transfer printer can rotate the feed roller 8 in a state regulating the position thereof in the axial direction (along arrows A1 and B1 in FIG. 14). Thus, the thermal transfer printer can inhibit the feed roller 8 from moving in the axial direction (along arrows A1 and B1 in FIG. 11) when carrying the paper 50, thereby inhibiting the same from deviation in the axial direction (along arrows A1 and B1 in FIG. 14). Therefore, the thermal transfer printer can inhibit the paper 50 held between the feed roller 8 and a press roller 10 from moving in the axial direction (along arrows A1 and B1 in FIG. 14) when carrying the paper 50 for printing, thereby suppressing reduction of printing quality.

According to the second embodiment, the feed roller 8 is provided with the gear receiving portion 8a receiving the feed roller gear 9 while the projecting portion 37c of the tongue section 37b is provided to come into contact with the portion close to the rotation center of the side end surface of the gear receiving portion 8a of the feed roller 8 so that the contact length (corresponding to the circumferential length) between the projecting portion 37c and the side end surface of the gear receiving portion 8a of the feed roller 8 can be reduced in rotation, thereby preventing the projecting portion 37c from abrasion resulting from rotation of the feed roller gear 9.

According to the second embodiment, both of the motor bracket 37 having the tongue section 37b and the feed roller 8 are made of metal while the tongue section 37b is provided to come into contact with the feed roller 8 so that charge (static electricity) stored in the feed roller 8 rotatively coming into contact with the paper 50 can be released toward the motor bracket 37 through the tongue section 37bwith no requirement for an additional member for earthing (grounding), whereby the thermal transfer printer can earth the feed roller 8 while inhibiting the number of components from increase.

The remaining effects of the second embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while each of the aforementioned first and second embodiments is applied to the thermal transfer printer employed as an exemplary printer, the present invention is not restricted to this but is also applicable to another type of printer so far as the same comprises a feed roller and a feed roller gear.

While the tongue sections 17b and 37b employed as exemplary urging portions according to the present invention are provided by notching the motor brackets 17 and 37 in the aforementioned first and second embodiments respectively, the present invention is not restricted to this but the motor bracket 17 or 37 may alternatively be mounted with a compression coil spring in place of the tongue section 17b or 37b.

While the tongue section 17b has the projecting portion 17c coming into contact with the feed roller gear 9 in the aforementioned first embodiment, the present invention is not restricted to this but the tongue section 17b may alternatively be so formed as to protrude toward the feed roller gear 9 to come into contact with the feed roller gear 9, with no projecting portion 17c provided thereon.

While the tongue section 37b has the projecting portion 37c coming into contact with the gear receiving portion 8a of the roller gear 8 in the aforementioned second embodiment, the present invention is not restricted to this but the tongue section 37b may alternatively be so formed as to protrude toward the roller gear 8 to come into contact with the roller gear 8, with no projecting portion 37c provided thereon.

While the tongue sections 17i b and 37b are L-shaped in the aforementioned first and second embodiments respectively, the present invention is not restricted to this but the tongue section 17b or 37b may alternatively be linearly formed.

While the tongue sections 17b and 37b are formed on the motor brackets 17 and 37 in the aforementioned first and second embodiments respectively, the present invention is not restricted to this but a dedicated platelike member having the tongue section 17b or 37b may alternatively be provided or the tongue section 17b or 37b may alternatively be provided on a bracket member for mounting another component on the thermal transfer printer.

While the tongue section 17b comes into contact with the side end surface of the rib 9c of the feed roller gear 9 to urge the feed roller gear 9 in the axial direction in the aforementioned first embodiment and the tongue section 37b comes into contact with the side end surface of the gear receiving portion 8a of the feed roller 8 to urge the feed roller 8 mounted with the feed roller 9 in the axial direction in the aforementioned second embodiment, the present invention is not restricted to this but the thermal transfer printer may alternatively be provided with a motor bracket having a tongue section coming into contact with the side end surfaces of both of the feed roller gear 9 and the feed roller 8.

What is claimed is:

1. A printer comprising:
a feed roller carrying a paper;
a feed roller gear mounted with said feed roller for transmitting driving force to said feed roller; and
a platelike member having an elastically deformable urging portion axially urging at least either said feed roller gear or said feed roller.

2. The printer according to claim 1, wherein
said platelike member includes a bracket member for mounting a prescribed component, and
said urging portion includes an elastically deformable tongue section formed by notching said bracket member.

3. The printer according to claim 2, wherein
said tongue section of said bracket member has a projecting portion provided to protrude from a surface of said bracket member closer to said feed roller gear or said feed roller for coming into contact with at least either said feed roller gear or said feed roller.

4. The printer according to claim 3, wherein
said projecting portion of said tongue section is provided to come into contact with the side end surface of at least either said feed roller gear or said feed roller.

5. The printer according to claim 4, wherein
said feed roller gear is made of resin and has a rib on a side opposed to said bracket member, and
said projecting portion of said tongue section is provided to come into contact with the side end surface of said rib of said feed roller gear.

6. The printer according to claim 4, wherein
said feed roller has a gear receiving portion for receiving said feed roller gear, and
said projecting portion of said tongue section is provided to come into contact with a portion close to the rotation center of the side end surface of said gear receiving portion of said feed roller.

7. The printer according to claim 3, wherein
said tongue section of said bracket member is L-shaped, and said projecting portion of said tongue section is provided in the vicinity of the forward end of said L-shaped tongue section.

8. The printer according to claim 1, wherein
said platelike member and at least either said feed roller gear or said feed roller are arranged at a prescribed interval, and
said prescribed interval is so set that said urging portion of said platelike member is deformed within the range of elastic deformation when at least either said feed roller gear or said feed roller is pressed by external force toward said platelike member to come into contact with said platelike member against said urging force of said urging portion of said platelike member.

9. The printer according to claim 1, wherein
said platelike member is a motor bracket mounted with a motor serving as a drive source for said driving force transmitted to said feed roller.

10. The printer according to claim 1, wherein
both of said platelike member having said urging portion and said feed roller are made of metal, and
said urging portion is provided to come into contact with said feed roller.

11. A printer comprising a feed roller carrying a paper and a feed roller gear mounted with said feed roller for transmitting driving force to said feed roller and further comprising a platelike member having an elastically deformable urging portion axially urging at least either said feed roller gear or said feed roller, wherein
said platelike member and at least either said feed roller gear or said feed roller are arranged at a prescribed interval,
said prescribed interval is so set that said urging portion of said platelike member is deformed within the range of elastic deformation when at least either said feed roller gear or said feed roller is pressed by external force toward said platelike member to come into contact with said platelike member against said urging force of said urging portion of said platelike member,
said platelike member is a motor bracket mounted with a motor serving as a drive source for said driving force transmitted to said feed roller,
said urging portion includes an elastically deformable tongue section formed by notching said motor bracket, and
said tongue section of said motor bracket is L-shaped, and has a projecting portion provided in the vicinity of the forward end of said L-shaped tongue section to protrude from a surface of said motor bracket closer to said feed roller gear or said feed roller for coming into contact with at least either said feed roller gear or said feed roller.

12. The printer according to claim 11, wherein
said projecting portion of said tongue section is provided to come into contact with the side end surface of at least either said feed roller gear or said feed roller.

13. The printer according to claim 11, wherein
said feed roller gear is made of resin and has a rib on a side opposed to said motor bracket, and
said projecting portion of said tongue section is provided to come into contact with the side end surface of said rib of said feed roller gear.

14. The printer according to claim 11, wherein
said feed roller has a gear receiving portion for receiving said feed roller gear, and
said projecting portion of said tongue section is provided to come into contact with a portion close to the rotation center of the side end surface of said gear receiving portion of said feed roller.

15. The printer according to claim 11, wherein
both of said platelike member having said urging portion and said feed roller are made of metal, and
said urging portion is provided to come into contact with said feed roller.
